(19) United States
(12) Patent Application Publication
(10) Pub. No.: US 2002/0108654 A1
(43) Pub. Date: Aug. 15, 2002

(54) Filter arrangement at a pressure regulator

(76) Inventors: Thomas A. Vreeland, Napa, CA (US); Donald E. Mitchell, Napa, CA (US)

Correspondence Address: KILPATRICK STOCKTON LLP, 607 14th STREET, NW, SUITE 900, WASHINGTON, DC, 20005, US

(21) Appl. No.: 09/682,463

(22) Filed: Sep. 6, 2001

Related U.S. Application Data
(63) Continuation-in-part of application No. 09/781,626, filed on Feb. 12, 2001.

(51) Int. Cl. B01D 51/00

(52) U.S. Cl. 137/550

(57) ABSTRACT

A compact arrangement and method for removing particulate generated by a fluid pressure regulator including location of a filter element within the pressure regulator or substantially adjacent thereto. Location of the filter element downstream of the regulating member and valve seat is disclosed. The fluid pressure regulator can be adapted to allow replacement of the filter element. The filter element and corresponding filter receiving space can be configured to account for different fluid flow ranges and particulate removal ratings.

### CROSS REFERENCE TO RELATED APPLICATIONS

The present application is a continuation-in-part of Application Ser. No. 09/781,626 filed Feb. 12, 2001, and entitled Filter Arrangement at a Pressure Regulator, the disclosure of which is expressly incorporated herein by reference in its entirety.

### BACKGROUND OF INVENTION

Fluid pressure regulators are well known. They are utilized in many applications and settings in which clean pressurized fluid sources are utilized and must be maintained. Examples include but are not limited to semiconductor chip manufacturing. Controlling the pressure of the fluid supply is typically carried out by utilizing a fluid pressure regulator. The purity of the pressurized fluid is achieved by placing a filter in the fluid flow to separate and trap contaminants out of the fluid. Contaminants can be caused by a number of sources. For example, the interaction between the pressure regulating member and the seal inside a fluid pressure regulator, for instance, a gas pressure regulator, can cause particulate to be dislodged off of the interactive components which are then swept into the passing fluid flow. Another example is particulates entering from the fluid supply or generated by other system elements such as valves. Presently, this problem is addressed by placing a particle filter somewhere upstream of the fluid pressure regulator as exemplified in U.S. Pat. No. 5,904,178 or downstream of the fluid pressure regulator as exemplified in SEMI F13. The environments in which these clean pressurized fluid supplies are utilized, however, typically provide only a minimum amount of space in which to locate both the regulator and filter. This can cause a significant problem in such industries as semiconductor chip manufacturing where available space for the fluid delivery system components is especially limited.

Several inventive arrangements and methods for filtering pressurized fluids are described hereinbelow that minimize or remedy these deficient aspects of known designs, and/or provide benefits, in and of themselves, to the user. These new, improved and otherwise potentiated solutions are described in greater detail hereinbelow with respect to several alternative embodiments of the present invention.

### SUMMARY OF INVENTION

In one aspect, the present invention removes particles that are generated by a fluid pressure regulator essentially at the point of generation by locating a particle filter within the pressure regulator. As described in further detail below, the particle filter is located immediately downstream of the pressure regulating member and its corresponding seal. This configuration results in a filtered, precisely pressured gas supply in a reduced amount of space.

In another aspect of the present invention, the fluid pressure regulator can be manufactured to allow internal inspections and/or replacement of the filter element. The filter element can be constructed into a variety of forms ranging from simple geometric shapes to more complex shapes to increase the filtration area and accommodate different fluid flow rates.

In a further aspect, the present invention removes particles that are generated by the fluid pressure regulator and other system elements downstream of the point of generation by locating a particle filter adjacent to the pressure regulator. As described in further detail below, the pressure regulator, a pressure sensor port and the particle filter are combined into a single package. Again, this configuration results in a filtered, precisely pressured gas supply in a reduced amount of space.

The general beneficial effects described above apply generally to the exemplary descriptions and characterizations of the devices, mechanisms and methods disclosed herein. The specific structures and steps through which these benefits are delivered will be described in detail hereinbelow.

### BRIEF DESCRIPTION OF DRAWINGS

In the following, the invention will be described in greater detail by way of examples and with reference to the attached drawings, in which:

FIG. 1 is a cross-sectional view of a fluid pressure regulator according to the present invention with an elongate cylindrical filter element positioned downstream of and adjacent to the pressure regulator.

FIG. 2 is a cross-sectional view of a conventional fluid pressure regulator.

FIG. 3a is cross-sectional view of a fluid pressure regulator according to the present invention with a cylindrical filter element positioned downstream of the regulating member and valve seat.

FIG. 3b is a detailed perspective view of a cylindrically-shaped filter element depicting radial fluid flow across the screen portion of the filter element.

FIG. 4a is a cross-sectional view of a fluid pressure regulator according to the present invention with a ring-shaped filter element positioned downstream of the regulating member and valve seat.

FIG. 4b is a detailed perspective view of a ring-shaped filter element depicting longitudinal or axial fluid flow across the screen portion of the filter element.

### DETAILED DESCRIPTION

As required, detailed embodiments of the present invention are disclosed herein; however, it is to be understood that the disclosed embodiments are merely exemplary of the invention(s) that may be embodied in various and alternative forms. The figures are not necessarily to scale; some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

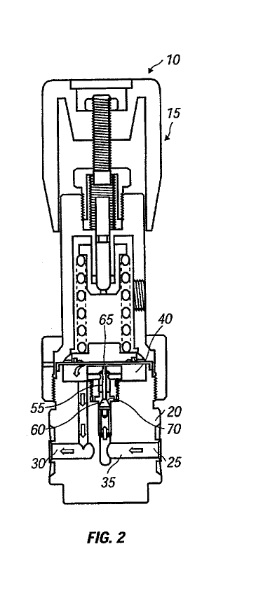

For illustrative purposes, a typical single stage fluid pressure regulator, as depicted in FIG. 2, includes a valve assembly 10 consisting of a top portion 15 and a pressure regulator housing 20. Formed within the housing 20 is a fluid flow path 35 which starts at a fluid supply inlet 25 and ends at a fluid supply outlet 30. A regulating member 55 and valve seat 70 are arranged in the housing 20 to control the fluid supply which flows along the fluid flow path 35. More particularly, the regulating member 55 is made up of a stem portion 65 at one end and a sealing body 60 at the other end which makes sealing engagement with the valve seat 70. The stem portion 65 causes the sealing body to separate or make sealing engagement with the valve seat 70 to precisely regulate the pressure of the fluid supply which flows along the fluid flow path 35. A low pressure cavity 40 is positioned in the fluid flow path 35 immediately downstream of the regulating member 55.

In order to maintain a relatively constant pressure downstream of the regulating member 55, the distance between the regulating member 55 and the valve seat 70 is varied when the pressure downstream of the regulating member 55 deviates from an initial set pressure. The distance increases when the downstream pressure drops below the initial set pressure and decreases (or closes) when the downstream pressure nears the initial set pressure. In short, the downstream pressure variations cause a reciprocating motion of opening and closing the distance between the regulating member 55 and the valve seat 70.

While other types of fluid pressure regulators, such as a double stage fluid regulators (not depicted), have different configurations and uses, each includes a regulating member 55 and a valve seat 70 which exhibit the reciprocating action described above. It is the experience of the inventors that the reciprocating action of the regulating member 55 causes particulate to be generated, especially when the regulating member 55 and the valve seat 70 contact and wear against each other. This causes particulate to contaminate the fluid flow path 35 at or downstream of the regulating member 55 and valve seat 70.

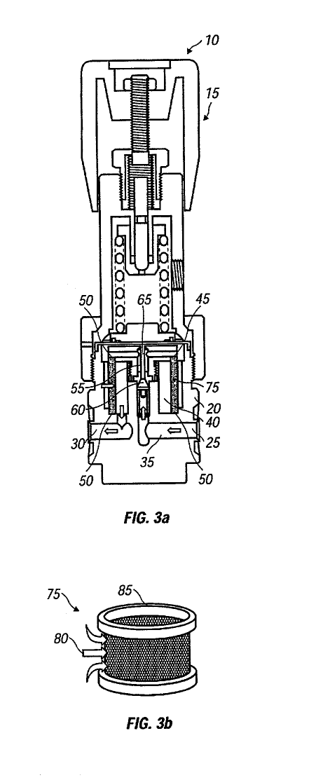

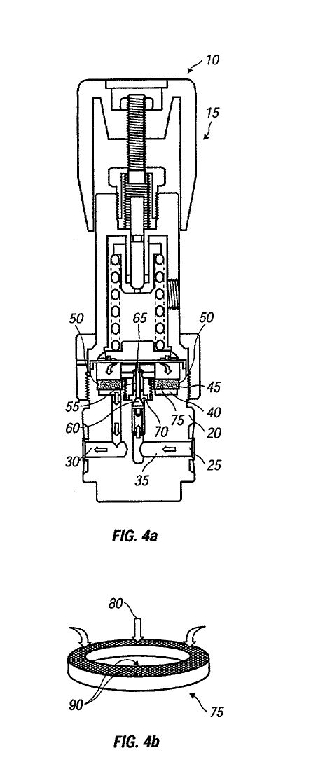

In one embodiment of the present invention, the fluid pressure regulator is similar in make up to the typical valve assembly 10 described above. The invention lies in part with the configuration of the low pressure cavity 40 to receive a filter element 75 thereby making a compact fluid pressure regulator and filter. In the present invention, the low pressure cavity 40 as shown in FIGS. 3a and 4a is formed with a filter receiving space 45 configured to receive and accommodate a filter element 75. In a preferred embodiment, the filter element 75 includes a sealing portion 85 which sealably engages the filter receiving space 45 at a filter engagement surface 50. Although not depicted, one skilled in the art can appreciate that the filter element 75 can be configured for bolting or screwing into the filter receiving space 45. This arrangement allows the filter element 75 to be removable. In an alternative embodiment, the filter element 75 includes a weld receiving portion 90 which mates with the filter engagement surface 45. A weld at the interface between the weld receiving portion 90 and the filter engagement surface 45 permanently seals the filter element 75 into the filter receiving space 45.

As depicted in FIGS. 3b and 4b, the filter element 75 includes a screen portion 80 which can be made from a variety of materials including but not limited to nickel, stainless steel and polytetrafluoroethylene (PTFE). The sealing portion 85 as shown in FIG. 3b can be made from a variety of materials which allow resealable engagement of the filter element 75 in the filter receiving space 45. Likewise, the weld receiving portion of the filter element 75 can be made from those materials which allow welding to occur with the filter engagement surface 50.

The shape and size of the filter element 75 and filter receiving space 45 can be adjusted to account for different flow ranges and particle removal ratings. For example, in FIGS. 3a and 3b, the filter element 75 is configured as a hollow tube or cylinder, with the sealing portion 85 located at the ends of the tube/cylinder. The filter receiving space 45 is shaped to accept and seal the ends the filter element 75 so that the fluid flow is radial through the screen portion 80. In another example as depicted in FIGS. 4a and 4b, the filter element 75 is configured in a washer or ring-shape with a longitudinally measured length extending between the two ends. The weld receiving portions 90 are located at the inner and outer circumferences of each end and mate with the filter engagement surface 50. The filter receiving space 45 is shaped to accept and seal by welding the weld receiving portion 90 of the filter element 75 so that the fluid flow is longitudinally through the screen portion 80.

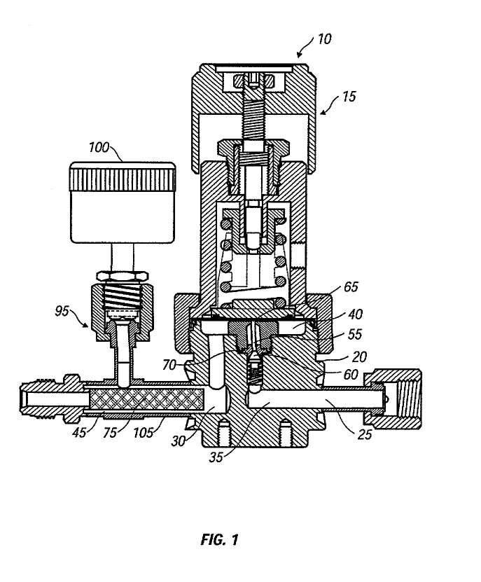

In another embodiment of the present invention, as depicted in FIG. 1, particles that are generated by the fluid pressure regulator and other system elements are removed downstream of the point of generation by locating a particle filter 75 substantially adjacent to the pressure regulator. The pressure regulator, a pressure sensor port 95 and the particle filter 75 are combined into a single package. Specifically, the particle filter 75 is partially disposed within the pressure sensor port tee 105, and may be partially disposed within the pressure regulator housing 20. The pressure sensor port 95 is a port suitable for receiving a pressure sensor 100, such as a pressure gauge or a transducer. The particle filter 75 includes an elongate cylindrical filter element. Advantageously, this configuration results in a filtered, precisely pressured gas supply in a reduced amount of space.

Although the present invention has been described and illustrated in detail, it is to be clearly understood that the same is by way of illustration and example only, and is not to be taken as a limitation. The spirit and scope of the present invention are to be limited only by the terms of any claims presented hereafter.

1. A compact fluid pressure regulated valve arrangement, said arrangement comprising:
a pressure regulator housing configured for inclusion in the compact fluid pressure regulated valve arrangement, said housing having: a filter receiving space formed in said housing and a regulating member arranged for reciprocating motion disposed in said housing for controlling a gas supply that flows along a gas flow path formed, at least partially, in said housing; and
a filter element in said filter receiving space, said filter element being at least partially disposed in said housing, said location of said filter element being downstream of said regulating member with respect to said gas supply that flows along said gas flow path thereby assuring that any particulate freed by operation of said regulating member and any other component located upstream of said filter element along said gas flow path is captured at said filter element thereby delivering an assured clean gas supply downstream of said compact fluid pressure regulated valve arrangement.

2. The arrangement as recited in claim 1 further comprising:
a pressure sensor port tee, said filter element being at least partially disposed in said tee.

3. The arrangement as recited in claim 1 further comprising:
an entrance provided to said gas flow path formed, at least partially, in said housing in the form of an fluid supply inlet.

4. The arrangement as recited in claim 1 further comprising:
an exit provided to said gas flow path formed, at least partially, in said housing in the form of an fluid supply outlet.

5. The arrangement as recited in claim 1 further comprising:
said filter element configured to be releasably engageable in said filter receiving space.

6. The arrangement as recited in claim 1 further comprising:
said filter element configured to be permanently fixed in said filter receiving space.

7. The arrangement as recited in claim 8 further comprising:
said filter element configured as an elongate cylinder having a longitudinally measured length extending between two ends of said filter element.
